(19) United States
(12) Patent Application Publication
(10) Pub. No.: US 2021/0163794 A1
(43) Pub. Date: Jun. 3, 2021

(54) A PROTECTIVE FILM

(71) Applicant: Winn & Coales International Limited, Greater London (GB)

(72) Inventor: Brian Dunsterville, Greater London (GB)

(21) Appl. No.: 15/734,063

(22) PCT Filed: May 29, 2019
(86) PCT No.: PCT/GB2019/051461

§ 371 Date: Dec. 1, 2020

(30) Foreign Application Priority Data
Jun. 1, 2018 (GB) 1809026.6

(51) Int. Cl. C09J 7/40; F16L 57/06; F16L 58/16; F16L 55/168; F16L 58/10

(52) U.S. Cl. CPC C09J 7/403; F16L 57/06; F16L 58/16; C09J 2467/005; F16L 58/1063; C09J 7/401; F16L 55/1683

(57) ABSTRACT

The present invention provides an adhesive protective film for protecting pipework, the film comprising: a protection layer; a release layer; and an adhesive between the protection and release layer. The release layer comprises a first plurality of uniformly spaced failure initiation locations provided along a first edge of the release layer for initiating tearing of the protective film; and the release layer is at least 50 μm thick.

The present invention relates to an adhesive protective film for protecting objects, in particular pipework. It is generally known in the art to use a protective film in order to protect pipework against corrosion, abrasion, and other potentially damaging actions.

Such protective films are generally provided as a protection layer which is supplied on a release layer. The release layer allows the protective film to be formed into a roll for transport and storage without the protection layer sticking to itself. In use, the protection layer is peeled from the release layer and applied to the surface to be protected. The excess release layer is then cut from the roll of material and disposed of.

Such cutting either requires cutting tools and hence increases the complexity of the process or alternatively requires a thinner release layer which can be torn by hand but which will necessarily not protect the protective film as well as a thicker, non-tearable, release layer.

JP 2013127582 A discloses an acoustic insulation fixing tape.

US 2015/204476 A1 discloses a unidirectional fiber composite system for structural repairs and reinforcements.

US 2013/228267 A1 discloses a double-sided pressure-sensitive adhesive tape and method for attaching the same and release liner.

CN 204474576 U discloses an adhesive tape.

CN 207347475 U discloses a multi-functional electromagnetic shield sticky tape.

CN 106494934 A discloses an adhesive tape with notches.

CN 205368227 U discloses a double-side adhesive tape.

Accordingly, it is desirable to provide an improved adhesive protective film and/or to tackle at least some of the problems associated with the prior art or, at least, to provide a commercially viable alternative thereto.

An adhesive protective film according to the present invention is provided according to claim 1. The film comprises: a protection layer; a release layer; an adhesive between the protection and release layer, wherein: the release layer comprises a first plurality of uniformly spaced failure initiation locations provided along a first edge of the release layer for initiating tearing of the protective film; and the release layer is at least 50 μm thick.

The present invention will now be further described. In the following passages different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

The failure initiation locations allow easy tearing of the release layer despite its increased thickness when compared to conventional release layers. As tear resistance is typically a function of the thickness of a layer, the increased thickness would typically result in an increased tear resistance but for the failure initiation locations. This enhances the ease of use of the protective film during application as well as allowing a thicker release layer which is more rigid than a thinner layer for enhanced protection during transport and storage. In particular, the enhanced rigidity may prevent the protection layer from being crushed by the weight of the roll in storage and transportation when orientated with its longitudinal axis upright. The rigidity may also help maintain the flatness of the protection layer to control and/or prevent unsightly wrinkling of the protection layer during manufacture.

The protective film may further comprise a second plurality of uniformly spaced failure initiation locations provided along the first edge of the release layer, each of the second plurality of uniformly spaced failure initiation locations being adjacent to a corresponding one of the first plurality of uniformly spaced failure initiation locations. This provides a regularly repeating set of failure points for any desired length of release layer to be torn off.

The release layer is at least 50 μm thick. This provides a reassuring thickness and support to the rolled film. This is thicker than a standard release film where such a thickness would cause difficulties in ripping the film during use. Preferably the release layer is from 50 μm to 200 μm, preferably 75 to 125 μm.

The film may be substantially rectangular with the release layer defining its outer boundaries and the first edge forming one of the long edges of the rectangle, such that the film can be formed into a roll with the first edge generally perpendicular in the longitudinal direction of the roll. The roll is a particularly convenient way for transporting large amounts of the protective film.

The failure initiation locations may be only provided on the first edge. Having the failure initiation locations provided only on the first edge means that, when the film is made into the roll, there is a bottom edge with no failure initiation locations which can be handled easily by a person transporting it without the need for protective gloves or the like. The failure initiation locations may be relatively sharp and could damage an installer's hand.

The release layer may be a polyester, preferably polyethylene terephthalate (PET). Polyesters, in particular polyethylene terephthalate, provide the desired protection characteristics for the protection layer. Alternatively, the release layer may be polyethylene. Suitable materials are well known in the art for each of the three layers forming the film. However, the release layer is provided with a greater thickness than standard.

The term, “polyethylene” as used herein, refers to a polymer that comprises, in polymerized form, a majority amount of ethylene monomer (based on the weight of the polymer), and optionally may comprise one or more comonomers. Similarly, PET may contain minor amounts of other monomer units.

Each failure initiation location may be formed as a symmetrical notch in the release layer. Providing the failure initiation locations as symmetrical notches helps to ensure that the tear begins in a direction perpendicular to the first edge for a generally straight tear.

Preferably each failure initiation location has a triangular wave profile forming the notch. A triangular wave profile is easy to produce and results in the desired symmetrical notch.

The amplitude of the triangular wave profile may be between 1 and 3 mm, preferably 2 mm. The triangular wave profile may be between 5 and 7 mm, preferably 6 mm. These particular dimensions produce a series of notches which are particularly suitable for initiating tearing.

Each failure initiation location may further comprise a slit cut into the release layer at an apex of the notch. The slit in the release layers encourages initiation of tearing at the given point.

The adhesive may cover substantially all of the protection layer; and the release layer may extend beyond the protection layer such that the first edge of the release layer is spaced from a first edge of protection layer for initiating tear in the release layer before the protection layer, preferably the first edge of the release layer is spaced from the first edge of the protection layer by at least 5 mm.

The protection layer may have a thickness of between 100 and 1000 μm, such as 200 to 400 μm; and/or the adhesive may have a thickness of between 500 and 1500 μm, such as 800 to 1200 μm.

The adhesive is able to be bonded more strongly to the protection layer than the release layer. This allows the protection layer and adhesive to detach from the release layer for further application to the pipework.

A method according to the present invention is provided in accordance with claim 14. The method comprises the steps of: peeling a first length of the release layer of the protective film from the adhesive and protection layer; applying the first length of adhesive and protection layer of the protective film to a surface; applying a force at or near to a point of weakness of the release layer to tear the release layer and remove the first length of release layer. The steps of applying the first length of adhesive and protection layer of the protective film to a surface and applying a force at or near to a point of weakness of the release layer to tear the release layer and remove the first length of release layer, can be performed in either order. Such a method allows the benefits to be discussed above with the respect to the product to be achieved.

Preferably the method further comprises: peeling a second length of the release layer of the protective film from the adhesive and protection layer; applying the second length of adhesive and protection layer of the protective film to the surface; and applying a force at or near to a further point of weakness of the release layer to tear the release layer and remove the second length of release layer.

The present invention is also embodied in the use of a plurality of uniformly spaced failure initiation locations provided along a first edge of a release layer in a protective film to initiate tearing of the release layer, wherein the release layer is at least 50 μm thick.

This use allows the advantages discussed above with respect to the product to be achieved.

The present invention will now be described with respect to the Figures in which:

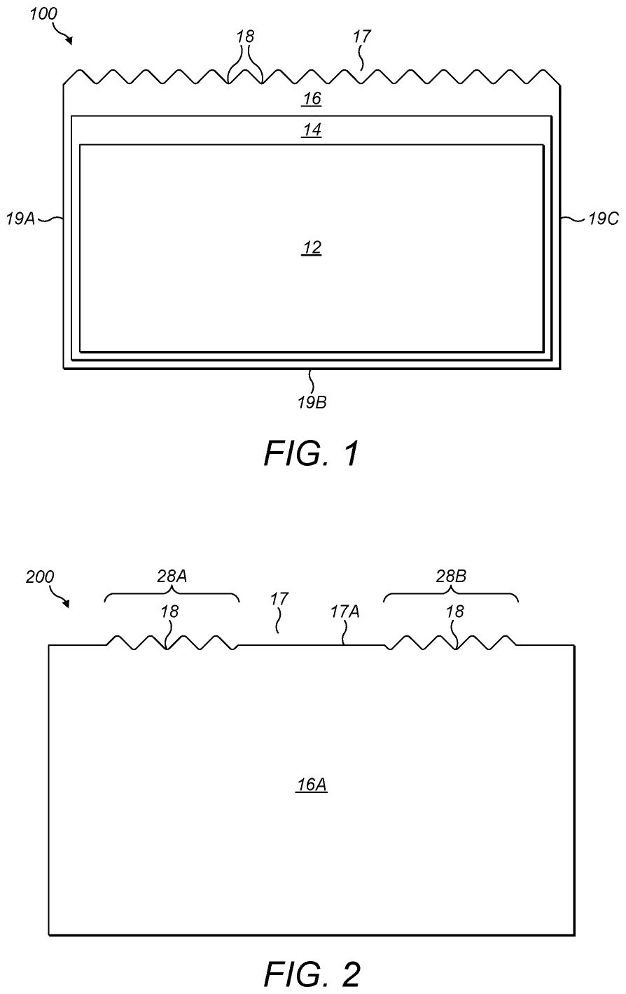

FIG. 1 shows a schematic view of a protective release film according to the present invention;

FIG. 2 shows an alternative example of a protective film;

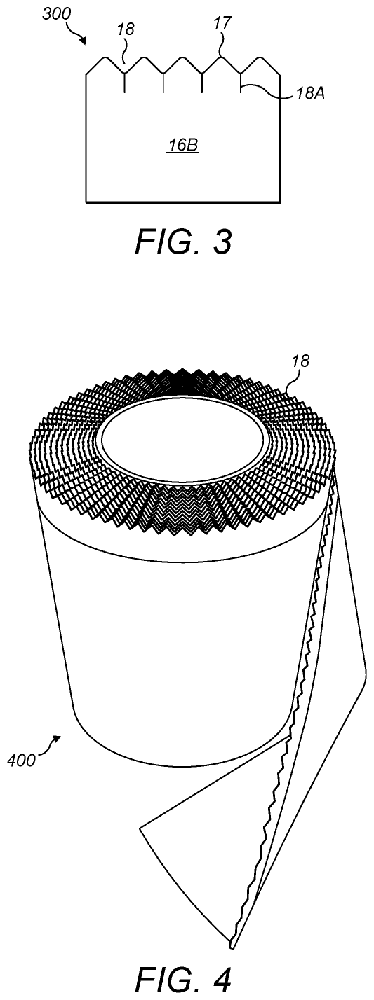

FIG. 3 shows an alternative example of the protective film of FIG. 1; and

FIG. 4 shows an example roll of the protective film of the present invention.

FIG. 1 shows a protective film 100 according to the present invention. The protective film 100 is formed of a protection layer 14 an adhesive 12 and a release layer 16. The adhesive 12 is provided between the protection layer 14 and release layer 16. The release layer 16 is generally stronger than the other two layers and protects these two layers, particularly in transit.

The release layer 16 is provided with a plurality of failure initiation locations 18. Only two of these are provided with reference numerals in FIG. 1 for brevity. However, as can be appreciated from this Figure these failure initiation locations 18 extend generally along the length of a first edge 17 of the release layer 16. Each failure initiation location 18 is evenly spaced from an adjacent failure initiation location 18. In particular, in the embodiment of FIG. 1 each failure initiation location 18 is provided as a symmetrical notch in the first edge 17 of the release layer 16. These symmetrical notches are formed with a triangular wave profile as shown in FIG. 1. The triangular wave profile has an aptitude of between 1 and 3 mm and, preferably 2 mm. The triangle wave profile further has a wavelength of between 5 and 7 mm, preferably 6 mm. Each of these failure initiation locations 18 enhances the ease of tearing the release layer 16.

In the depicted embodiment these failure initiation locations 18 are only provided along the first edge 17 of the release layer 16 and not on any of the remaining edges 19A, 19B, 19C. The release layer 16 is generally rectangular in shape and, as such, can be readily rolled into a cylindrical roll 400 as depicted in FIG. 4 with the failure initiation locations 18 (only one indicated in FIG. 4) provided on one edge of the roll 400.

In use, the release layer 16 is processively peeled from the adhesive 12 and protection layer 14 to expose the adhesive 12 which is sandwiched between the other two layers. The adhesive 12 is more strongly bonded to the protection layer 14 than to the release layer 16 and as such is retained by the protection layer 14 when the release layer 16 is removed. The protection layer 14 and adhesive 12 are then applied to a surface which is to be protected by the protection layer 14. In particular, the present invention is envisioned to be used to protect pipework. In this case, the adhesive 12 and protection layer 14 will be applied to the pipework such that the adhesive 12 bonds the protection layer 14 to the pipework. The protection layer 14 then forms an outer surface of the pipework and protects it from damage.

As the protection layer 14 and adhesive 12 are applied to the surface a build-up of spent release layer 16 will be formed as the other layers are removed therefrom. Once the application is complete, or when the excess of release layer 16 becomes too unwieldy, the installer initiates a tear in the release layer 16 at one of the failure initiation locations 18. This tear is then propagated across the rest of the release layer 16 to detach the excess spent release layer 16 from the protective film 100. This allows the excess release layer 16 to be easily removed and disposed of either at completion of application, or when it is getting in the way.

By providing the failure initiation locations 18 in the release layer 16, the release layer 16 can be made thicker than traditional release layers. In particular, the release layer 16 may be at least 50 μm thick. Such a thick release layer would not be readily tearable without the use of additional tools but for the failure initiation locations 18. As such, the thicker release layer 16 provides enhanced protection to the protection layer 14 underneath.

FIG. 2 depicts an alternative arrangement of failure initiation locations 18 on a release layer 16A. The adhesive 12 and protection layer 14 have been omitted from FIG. 2 as they are generally identical to those shown in FIG. 1. Each failure initiation location 18 is generally formed as in the embodiment of FIG. 1. However, in this embodiment a portion 17A of the first edge 17 is provided between first and second sets 28A, 28B of failure initiation locations 18. The portion 17A of the first edge 17 between these regions 28A, 28B is provided without any failure initiation locations 18. In certain examples, this portion 17A may be approximately 1 metre long to allow for discrete 1 metre strips of release layer 16A to be removed.

FIG. 3 shows a close-up of the failure initiation locations 18 of a further release layer 16B. Again, the adhesive 12 and protection layer 14 have been omitted from this Figure as they are generally identical to FIG. 1. Each of the failure initiation locations 18 is further provided with a notch 18A in the release layer 16B. The notch 18A may be formed as a slit which encourages propagation of the tear in a direction generally perpendicular to the first edge 17.

Each of the embodiments described above achieves the advantages set out in the statement of invention with respect to an easier application and the ability to use a thicker release layer than would traditionally be applied.

Although preferred embodiments of the invention have been described herein in detail, it will be understood by those skilled in the art that variations may be made thereto without departing from the scope of the invention or of the appended claims.

1. An adhesive protective film for protecting pipework, the protective film comprising:
a protection layer;
a release layer includes a first plurality of uniformly spaced failure initiation locations along a first edge of the release layer, the first plurality of uniformly spaced failure initiation locations configured and arranged to initiate tearing of the protective film along the first edge; and
an adhesive between the protection and release layer;
wherein
the release layer is at least 50 μm thick.

2. The protective film of claim 1, further comprising
a second plurality of uniformly spaced failure initiation locations provided along the first edge of the release layer, each of the second plurality of uniformly spaced failure initiation locations being adjacent to a corresponding one of the first plurality of uniformly spaced failure initiation locations.

3. The protective film of claim 1, wherein the protective film is substantially rectangular with the release layer defining outer boundaries of the protective film and the first edge forms one of the long edges of the rectangle, such that the protective film is configured and arranged to be rolled with the first edge generally perpendicular in the longitudinal direction of the roll.

4. The protective film of claim 3, wherein the failure initiation locations are only provided along the first edge.

5. The protective film of claim 1, wherein the release layer is a polyester.

6. The protective film of claim 1, wherein each failure initiation location is formed as a symmetrical notch in the release layer.

7. The protective film of claim 6, wherein each failure initiation location has a triangular wave profile forming a notch in the release layer.

8. The protective film of claim 7, wherein the amplitude of the triangular wave profile is between 1 and 3 mm.

9. The protective film of claim 7, wherein the wavelength of the triangular wave profile is between 5 and 7 mm.

10. The protective film of any of claims 6, wherein each failure initiation location of the first plurality of failure initiation locations includes a slit cut into the release layer at an apex of a symmetrical notch in the release layer.

11. protective film of claim 1, wherein:
the adhesive covers substantially all of the protection layer; and
the release layer extends beyond the protection layer such that the first edge of the release layer is spaced from a first edge of protection layer and configured and arranged for initiating a tear in the release layer before the protection layer.

12. The protective film of claim 1, wherein:
(i) the protection layer has a thickness of between 100 and 1000 μm; and/or
(ii) the adhesive has a thickness of between 500 and 1500 μm.

13. The protective film of claim 1, wherein the adhesive is bonded more strongly to the protection layer than the release layer.

14. A method of applying one or more layers of a protective film to a surface, the method comprising the steps of:
peeling a first length of a release layer off the protective film from an adhesive and a protection layer;
applying the first length of adhesive and protection layer of the protective film to a surface;
applying a force at or near to a point of weakness of the release layer to tear the release layer and remove the first length of release layer.

15. The method of claim 14, further comprising the steps of:
peeling a second length of the release layer of the protective film from the adhesive and protection layer;
applying the second length of adhesive and protection layer of the protective film to the surface; and
applying a force at or near to a further point of weakness of the release layer to tear the release layer and remove the second length of release layer.

16. (canceled)

17. The method of claim 14, wherein the protective film includes:
the protection layer;
the release layer includes a first plurality of uniformly spaced failure initiation locations along a first edge of the release layer, the first plurality of uniformly spaced failure initiation locations configured and arranged to initiate tearing of the protective film along the first edge; and
the adhesive between the protection and release layer;
wherein the release layer is at least 50 μm thick.

18. A method of using a protective film including the steps of:
providing a protective film including a plurality of uniformly spaced failure initiation locations along a first edge of a release layer of the protective film;
initiating tearing along the release layer via the plurality of uniformly spaced failure initiation locations;
wherein the release layer is at least 50 μm thick.
